(19) United States
(12) Patent Application Publication
(10) Pub. No.: US 2011/0063076 A1
(43) Pub. Date: Mar. 17, 2011

(54) Apparatus for preventing unauthorized use of a vehicle

(75) Inventors: Michael Kurtz, Lake in the Hills, IL (US); Stefan Dziaba, Cortland, IL (US)

(73) Assignee: OMRON Automotive Electronics, Inc., Schaumburg, IL (US)

(21) Appl. No.: 12/923,006

(22) Filed: Aug. 27, 2010

Related U.S. Application Data
(60) Provisional application No. 61/237,996, filed on Aug. 28, 2009.

(51) Int. Cl. G06F 7/04

(52) U.S. Cl. 340/5.61

(57) ABSTRACT

An apparatus for protecting a vehicle includes a fob in the possession of a person who whishes to use the vehicle. The fob includes a fob code. A proximity sensor mounted on the vehicle is used to actuate circuitry for interrogating the fob so as to retrieve the fob code. The fob code is then matched to a vehicle code to determine whether the person possessing the fob is authorized to use the vehicle. The proximity sensor may include a capacitive sensor, and inductive sensor, or both.

### CROSS-REFERENCE TO RELATED APPLICATION

This application claims the benefit of domestic priority of U.S. provisional application 61/237,996, filed Aug. 28, 2009. The disclosure of this provisional application is incorporated herein by reference.

### BACKGROUND OF THE INVENTION

The present application is directed to an apparatus for preventing unauthorized use of a vehicle.

Traditionally, keys have been used to deter unauthorized use of vehicles such as cars. An authorized user of a car is issued a key that is configured to mate with a mechanical lock provided in the car and then to permit the car to be started or stopped by twisting the key. Without access to the proper key, an unauthorized user is unable to easily start the car.

Recently, security has been increased by the use of so-called transponder keys or “chip” keys. When an attempt is made to start a car with such a key, an interrogation signal is transmitted to the key by circuitry in the car. An integrated circuit that is disposed in a fob associated with the key responds to the interrogation signal by sending a coded signal back to the circuitry in the car. Only if the coded signal received by the circuitry matches a stored code can the car be started.

While the enhanced security afforded by transponder keys is desirable, they are still keys and thus share inconvenient characteristics that are common to keys. For example, it can sometimes be a nuisance to orient a key properly for insertion into the lock, particularly at night. Furthermore, if a key and an electronic component such as a digital camera or a cell phone are carried in the same pocket or purse, the metal of the key may scratch the electronic component. This can inflict serious damage if a scratch occurs, for example, on the LCD screen of a digital camera.

### SUMMARY OF THE INVENTION

An object of the invention is to avoid the inconvenience of needing a key to operate a vehicle, without compromising security.

Another object is to permit an authorized person to operate a vehicle merely by carrying a fob and touching an activation region on a panel that is located, for example, on a dashboard. A proximity detector adjacent the activation region detects the touch.

Another object of the invention is to provide a solenoid assembly that permits magnetic coupling with a solenoid in a fob regardless of the orientation of the fob. To this end, the solenoid assembly preferably includes three orthogonally disposed solenoids.

Another object of the invention is to provide a way to reliably detect intentional actuation of a proximity switch.

These and other objects that will become apparent from the ensuing detailed description can be attained by providing an apparatus that includes a proximity sensor which is mounted on a vehicle and a fob which is detached from the vehicle, the fob having means for transmitting and receiving signals. The proximity sensor includes a capacitive sensor and/or an inductive sensor. The apparatus also includes means for transmitting an interrogation signal to the fob in response to manual activation of the proximity sensor, for receiving from the fob a signal that includes a fob code, and for determining whether the fob code matches a code assigned to the vehicle.

### BRIEF DESCRIPTION OF THE DRAWINGS

FIG. 1 is a block diagram of a first embodiment of an apparatus according to the present invention;

FIG. 2 is a schematic diagram of a solenoid assembly that is shown in FIG. 1;

FIG. 3 is a schematic diagram of a fob that is shown in FIG. 1;

FIG. 4 illustrates the dashboard of a car in which the embodiment of FIG. 1 is installed;

FIG. 5 is a sectional view taken along line 5-5 of FIG. 4;

FIG. 6 is a flowchart illustrating operation of the first embodiment; and

FIG. 7 is a block diagram of a second embodiment.

### DESCRIPTION OF THE PREFERRED EMBODIMENTS

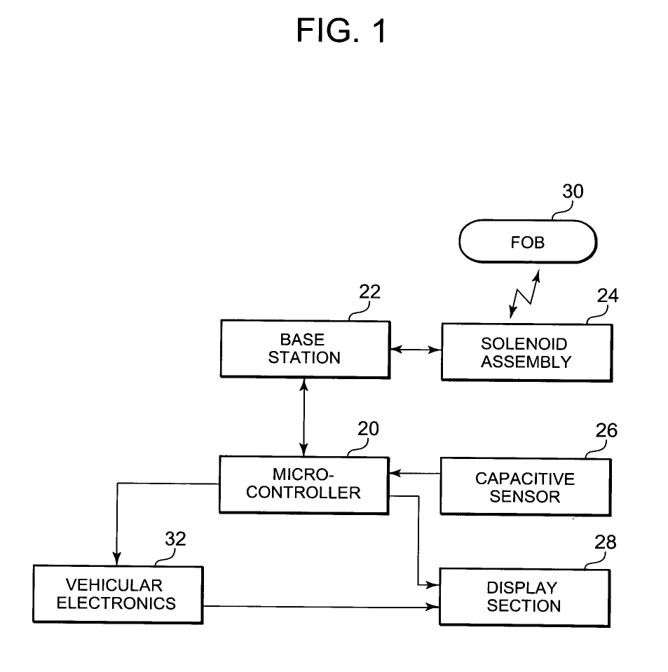

FIG. 1 illustrates a block diagram of a first embodiment of an apparatus for preventing unauthorized use of vehicle such as a car. The apparatus includes a microcontroller 20, a base station 22, a solenoid assembly 24, a proximity sensor such as capacitive sensor 26, and part of a display section 28. The elements 20-28 are mounted on the car. The apparatus also includes a fob 30 that is carried by a person who is authorized to use the car. The microcontroller 20 of the apparatus communicates with electrical systems for monitoring the car and for controlling the car in accordance with input by the driver. These electrical systems are identified in FIG. 1 simply as vehicular electronics 32.

An example of operation of the apparatus shown in FIG. 1 will now be described. A person who wants to start the car and who carries fob 30 touches a predetermined activation region and this touch is detected by capacitive sensor 26. The capacitive sensor 26 signals the microcontroller 20, which signals base station 22 to energize solenoid assembly 24. The solenoid assembly 24 then emits an alternating magnetic field that induces an alternating current in a solenoid (not shown in FIG. 1) in the fob 30. This alternating current provides power for circuitry in the fob 30. The alternating magnetic field emitted by solenoid assembly 24 also serves as an interrogation signal to the fob 30, which responds by emitting an encrypted code followed by an instruction (in this example, an instruction to start the car). The encrypted code in the instruction is received by base station 22 by way of solenoid assembly 24, and then sent to microcontroller 20. The microcontroller 20 decrypts the code and, if the decrypted code matches a code that has been assigned by the manufacture to the car, the microcontroller 20 forwards the instruction to vehicular electronics 32. Vehicular electronics 32 then starts the car. The car is stopped by touching the activation region again.

The alternating magnetic field emitted by solenoid 24 may have a frequency of 125 kHz.

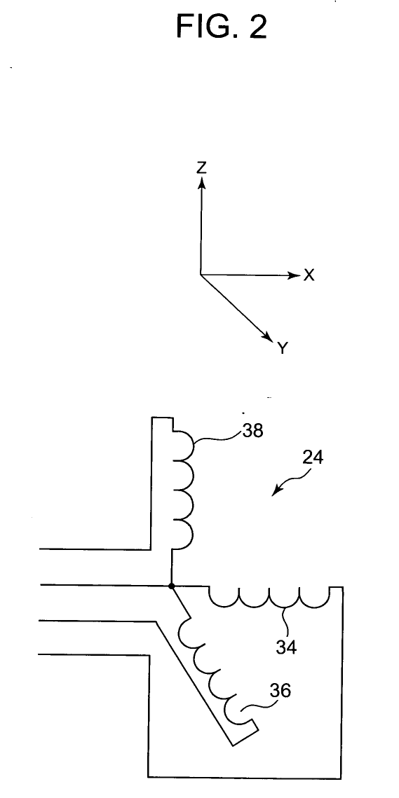

FIG. 2 shows the solenoid assembly 24, which includes a solenoid 34 that is oriented in the X direction, the solenoid 36 that is oriented in the Y direction, and a solenoid 38 that is oriented in the Z direction. The reason why three solenoids that are oriented in orthogonal directions are desirable is that fob 30 has a solenoid (not shown in FIG. 1) with an arbitrary orientation, since the orientation of fob 30 itself depends upon how it is carried. The three orthogonal solenoids in assembly 24 ensure that, regardless of the orientation of fob 30, the inductive coupling between the fob 30 and the solenoid assembly 24 will be adequate for transmission of power to the fob 30 and transmission of the encrypted code and the instruction from fob 30 to the solenoid assembly 24, if the fob 30 is located within a few feet of the solenoid assembly 24.

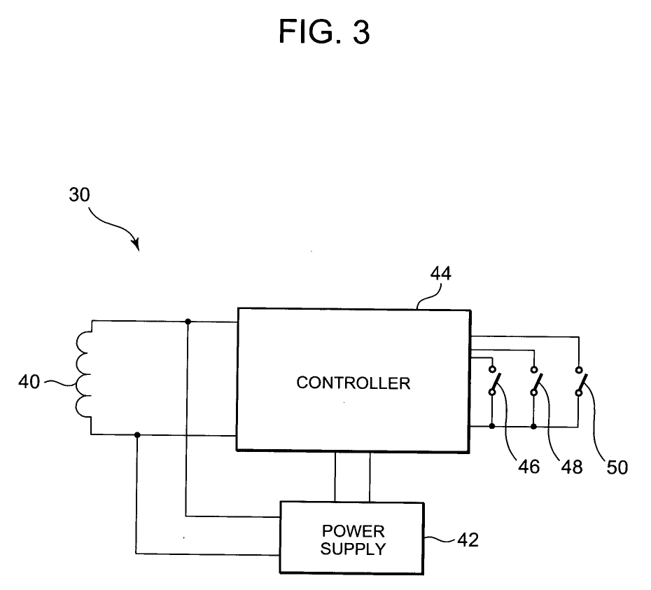

The construction of the fob 30 is illustrated in FIG. 3. The fob 30 includes a solenoid 40 that is inductively coupled to the solenoid assembly 24 when the fob 30 is located fairly close to the assembly 24. The alternating current induced in solenoid 40 is received by a power supply 42, which rectifies and filters the power and stores it on a capacitor (not illustrated). A controller 44 receives electricity from the power supply 42. The fob 30 in this embodiment includes three manually actuated, normally-open switches 46, 48, and 50. The person carrying the fob 30 closes switch 46 if the person wishes to start the car. Switches 48 and 50 provide an accessory mode and a run mode. In the accessory mode, some of the electrical equipment in the car (such as a radio) become operable. In the run mode, more of the electrical equipment becomes operable.

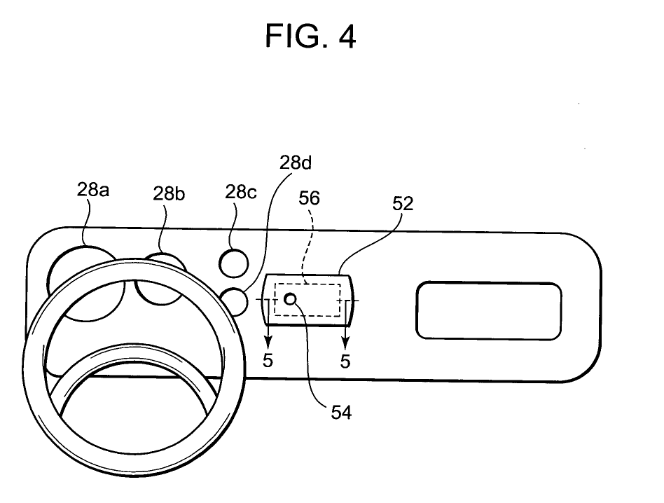

The dashboard of the car in the first embodiment is shown in FIG. 4, which illustrates such conventional features as a steering wheel (un-numbered) at the left of the drawing and a glove compartment (likewise un-numbered) at the right. The display section 28 (FIG. 1) includes display units 28a, 28b, 28c, and 28d that are controlled by the vehicular electronics 32. These display units may include, for example, a fuel display, a mileage display, a tachometer, and various warning indicators. The dashboard may also include a translucent panel 52 having a dimple 54 in it.

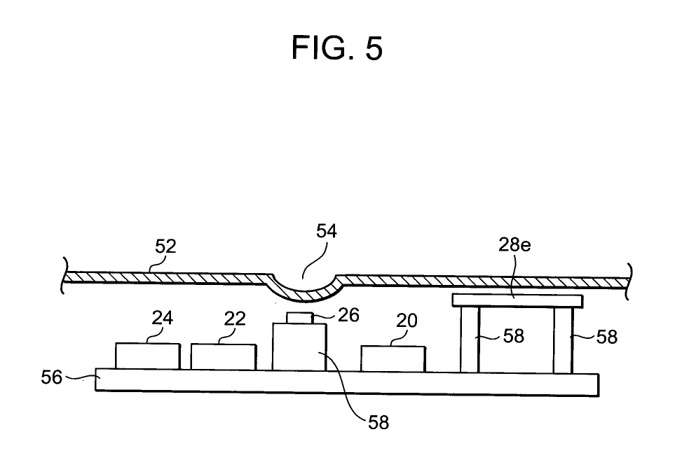

Turning now to FIG. 5, the assembly of the present embodiment (except for fob 30) is mounted on a printed circuit board 56 that is disposed beneath the panel 52. The capacitive sensor 26 is mounted on the platform member 58 and is closely spaced from the dimple 54, which serves as an activation region for the sensor 26. Pressure from an activating member such as a finger in the dimple 54 slightly deforms the panel 52 and changes the voltage that is supplied to a capacitor via a resistor (neither of which is shown) in the capacitive sensor 56. It is this change of voltage, if it is greater in magnitude than a predetermined threshold value Vₜ and if it persists longer than a predetermined threshold value Tₜ, that is interpreted by the microcontroller 20 as an activation signal.

With the continuing reference to FIG. 5, the display section 28 (FIG. 1) includes a display unit 28e that is mounted of spacers 58. Although not shown, the display unit 28e includes LEDs that are selectively activated to signal the start, accessory, and run modes.

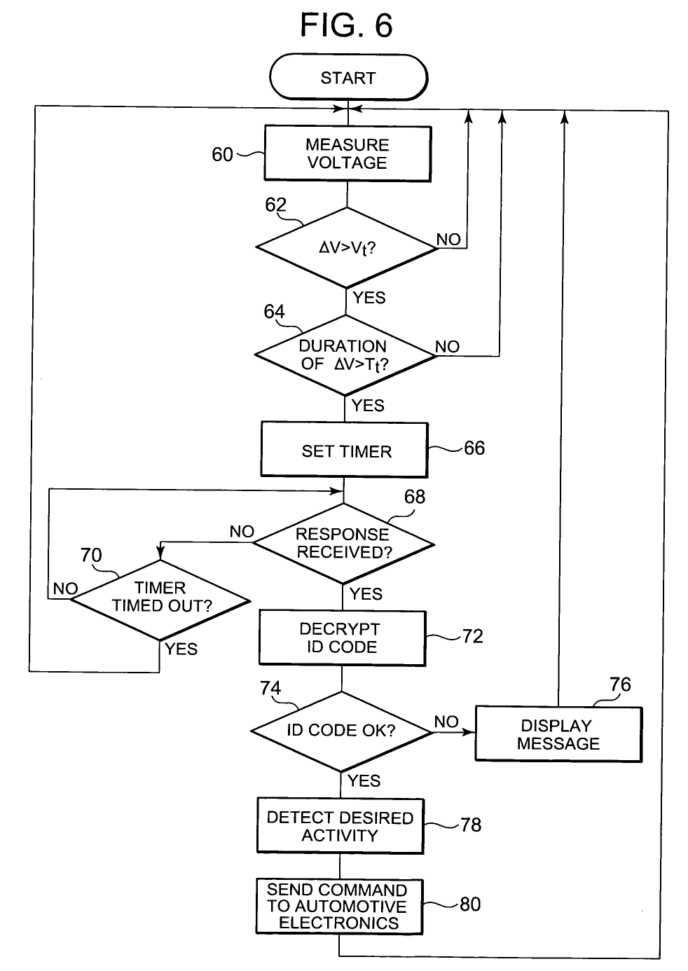

FIG. 6 is a flowchart illustrating the overall operation of the first embodiment. In step 60, the voltage across the capacitor (not illustrated) in capacitive sensor 26 is measured, and if this voltage changes, then the change ΔV is determined. In step 62, whether the voltage change ΔV is greater than the threshold Vₜ is determined. If not, the procedure returns to step 60 to continue measuring the voltage across the capacitor. However, if ΔV is greater than the threshold Vₜ, whether ΔV has stayed above Vₜ for longer than the threshold Tₜ is determined. If not, the procedure returns to step 60. However, if both thresholds are exceeded (“Y” at step 64), a valid triggering event (that is, pressure intentionally applied to the dimple 54 of FIG. 5) has been detected. Steps 62 and 64 are included in the procedure in order to exclude unintentional activities (such as cleaning the dashboard or accidentally bumping against it) from being interpreted as triggering events.

With continuing reference to FIG. 6, a timer in the microcontroller 20 is set in step 66. Whether a response has been received from the fob 30 is determined in step 68. If not, a check is made at step 70 to determine whether the timer has timed out. If not, the procedure returns to step 68 to await the response from fob 30. If the response has been received, the microcontroller 20 decrypts the ID code in the response in step 72 and determines, in step 74, whether the decrypted ID code corresponds to the ID code that was assigned to the car by its manufacturer. If the code is not OK, a message is displayed at step 76 (in this embodiment, by blinking all of the LEDs in the display unit 28e of FIG. 5) and the procedure returns to step 60. If the ID code is valid, the desired activity (that is, whether to start the car or to enter the accessory or run modes, depending upon which of switches 46-50 in FIG. 3 has been closed) is determined at step 78. A command to execute the desired activity is then sent to vehicular electronics 32 (FIG. 1) at step 80.

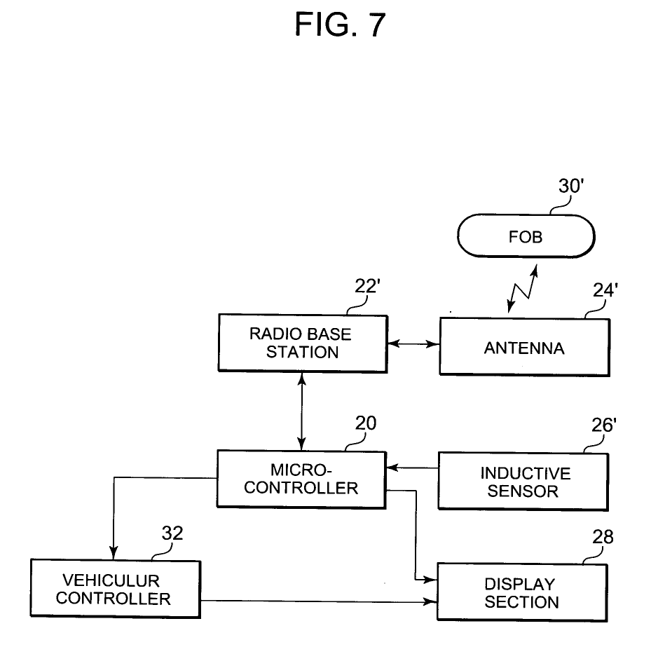

FIG. 7 is a block diagram of a second embodiment to the present invention. It is the same as the first embodiment except that an inductive sensor 26′ is used instead of the capacitive sensor 26 in the first embodiment, and also the communication with the fob is RF communication rather than communication based on magnetic interaction. For this reason, the second embodiment employs a radio base station 22′ instead of the base station 22 of the first embodiment and an antenna 24′ instead of the solenoid assembly 24. The fob 30′ that is used in the second embodiment includes an RF transceiver and lacks the solenoid 40 of the first embodiment.

It will be apparent to those skilled in the art that many changes and modification could be made in the embodiments that have been described above. Some of them will now be specifically mentioned.

Instead of the capacitive sensor 26 or the inductive sensor 26′, a proximity sensor that includes a capacitor and an inductive sensor could be used. In such a modification the capacitor of the capacitive sensor could be placed inside the coil of the inductive sensor. For example, the coil could be washer-shaped and the capacitor could be located in the center of the coil.

Another possible modification would be to use a panel 52 (FIG. 4) having three dimples instead of a single dimple 54. A proximity sensor would be placed behind each of the dimples. In this way, the driver could press different dimples to start the vehicle or enter the accessory or run modes, so that the switches of fob 30 that are shown in FIG. 3 could be eliminated. That is, the desired activity would be indicated by actuation of the appropriate proximity sensor rather than by closure of a switch on the fob.

The proximity sensor may be combined with a heptic device (such as piezoelectric vibrator) to provide tactile feedback for the user when the proximity sensor is actuated.

Instead of a capacitive and/or inductive sensor, a touch panel could be used. A driver could touch different locations on the touch panel to indicate the desired activity. Alternatively, a driver could use a finger to trace different paths over the touch panel (possibly paths such as “S” for start, “A” for the accessory mode, and “R” for the run mode) to identify the desired operation.

While FIGS. 4 and 5 show a dimple 54 in the panel 52, this is preferred but not necessary. The surface of the panel 52 may be uniform, or a blister may replace the dimple.

The fob can be configured to provide additional functions, particularly if it includes a battery instead of relying on power transmitted from the base station. For example, the switch could be included for locking or unlocking the doors, opening the trunk, and so forth.

The communication with the fob may be by way of magnetic coupling, such as the 3D 125 kHz bi-directional communication discussed above with respect to the first embodiment. The communication can also be by radio, such as a vehicle passive and/or remote command using 13.56 mHz NFC (Near Field Communications), or by coded infrared signals.

It will be understood that the above description of the present invention is susceptible to various other modifications, changes, and adaptations, and the same or intended to be comprehended within the meaning and a range of equivalents of the appended claims.

What we claim is:

1. An apparatus for limiting unauthorized use of a vehicle, comprising:
a proximity sensor mounted on the vehicle, the proximity sensor including at least one sensor selected from the group consisting of a capacitive sensor and an inductive sensor;
a fob having means for transmitting and receiving signals, the fob being detached from the vehicle; and
operative means for transmitting an interrogation signal to the fob in response to manual activation of the proximity sensor, for receiving from the fob a signal that includes a fob code, and for determining whether the fob code matched a code assigned to the vehicle.

2. The apparatus of claim 1, wherein the operative means comprises means for responding to a signal from the proximity sensor only if the signal has a magnitude that exceeds a predetermined magnitude threshold and a duration that exceeds a predetermined duration threshold.

3. The apparatus of claim 1, wherein the fob includes a solenoid and the operative means includes a solenoid assembly having three solenoids that are oriented in orthogonal directions.

4. The apparatus of claim 1, wherein the vehicle includes a dashboard, and the apparatus further comprises a panel mounted on the dashboard, the panel having an activation region that is disposed adjacent the proximity sensor.

5. The apparatus of claim 4, wherein the activation region is a surface irregularity in the panel.

6. The apparatus of claim 5, wherein the irregularity is a dimple in the panel.

7. The apparatus of claim 4, wherein the apparatus permits a plurality of operating modes, and further comprising signaling means disposed behind the panel for indicating which mode has been selected.

8. The apparatus of claim 7, wherein the modes include a start mode, an accessory mode, and a run mode.

9. The apparatus of claim 1, wherein the fob code is encrypted, and the operative means include means for decrypting the fob code.
